(19) United States
(12) Patent Application Publication
(10) Pub. No.: US 2024/0337811 A1
(43) Pub. Date: Oct. 10, 2024

(54) LENS MODULE AND CAMERA MODULE INCLUDING THE SAME

(71) Applicant: Samsung Electro-Mechanics Co., Ltd., Suwon-si (KR)

(72) Inventor: Sungyeon KIM, Suwon-si (KR)

(73) Assignee: Samsung Electro-Mechanics Co., Ltd., Suwon-si (KR)

(21) Appl. No.: 18/408,742

(22) Filed: Jan. 10, 2024

(30) Foreign Application Priority Data
Apr. 5, 2023 (KR) 10-2023-0045019

(51) Int. Cl. G02B 7/08; G02B 27/64

(52) U.S. Cl. CPC G02B 7/08; G02B 27/64

(57) ABSTRACT

A lens module is provided. The lens module includes a lens barrel that accommodates at least one lens; and a lens holder that is coupled to the lens barrel and includes a holder member which is formed of a first material and a yoke member that is disposed on the holder member along an inner edge of the holder member. A first groove is disposed at an inner circumferential surface of the yoke member, and the yoke member is formed of a second material that is different from the first material of the holder member.

### CROSS-REFERENCE TO RELATED APPLICATIONS

This application claims the benefit under 35 USC § 119 (a) of Korean Patent Application No. 10-2023-0045019 filed on Apr. 5, 2023, in the Korean Intellectual Property Office, the entire disclosure of which is incorporated herein by reference for all purposes.

### BACKGROUND

### 1. Field

The following description relates to a lens module and a camera module including the same.

### 2. Description of the Background

A camera module may typically be implemented in portable electronic devices such as, but not limited to, smart phone. The camera module includes a lens, a lens barrel at which the lens is mounted, and a lens holder that supports the lens barrel. One of methods of combining the lens barrel with the lens holder is to combine the lens barrel with the lens holder through an adhesive.

When the lens barrel is combined with the lens holder through the adhesive, there is a problem in which the adhesive overflows due to excessive injection of the adhesive, and during a curing process of the adhesive, an assembly position of the lens barrel may be changed or the lens disposed inside the lens barrel may be deformed based on the application of heat to cure the adhesive. Additionally, there is a problem in which the lens barrel may be deformed due to a difference in deformation behavior in which the lens barrel is expanded and contracted depending on a position of the lens barrel by ultraviolet (UV) irradiation and heat generation of the adhesive.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens module includes a lens barrel that accommodates at least one lens; and a lens holder that is coupled to the lens barrel and includes a holder member including a first material and a yoke member that is disposed on the holder member along an inner edge of the holder member, wherein a first groove is disposed at an inner circumferential surface of the yoke member, and the yoke member includes a second material that is different from the first material of the holder member.

The holder member may have a second groove that corresponds to the first groove disposed at the yoke member, and the second groove on a surface of the holder member that is opposite to the yoke member.

The second groove may be recessed in a direction of an optical axis from an upper surface of the holder member.

The holder member may have a plurality of corner regions, the first groove may include a plurality of first grooves, and each of the plurality of first grooves may be disposed at the corner regions of the holder member.

Each of the plurality of first grooves may be disposed to face each other in a diagonal direction of the yoke member.

A thermal conductivity of the yoke member may be higher than a thermal conductivity of the holder member.

A value obtained by multiplying a density of the second material by a specific heat of the second material may be greater than a value obtained by multiplying a density of the first material by a specific heat of the first material.

The yoke member may have a ring shape.

An adhesive may be filled in the first groove.

The first material may include polycarbonate (PC).

The second material may include stainless steel.

A bottom surface of the first groove may be flat.

The first groove may be recessed outward in a radial direction of the yoke member.

In a general aspect, a camera module includes a lens module; a housing that accommodates the lens module; a cover that covers an outer surface of the housing; and a circuit board, coupled to a lower portion of the housing, and having an image sensor mounted thereat, wherein the lens module includes a lens barrel that accommodates at least one lens, and a lens holder that is coupled to the lens barrel and includes a holder member including a first material and a yoke member disposed on the holder member along an inner edge of the holder member, and wherein a first groove is disposed at an inner circumferential surface of the yoke member, and the yoke member includes a second material that is different from the first material of the holder member.

The first groove may include a plurality of first grooves, and each of the plurality of first grooves is disposed to face each other in a diagonal direction of the yoke member.

A value obtained by multiplying a density of the second material by a specific heat of the second material may be greater than a value obtained by multiplying a density of the first material by a specific heat of the first material.

The yoke member may have a ring shape.

An adhesive may be filled in the first groove.

A bottom surface of the first groove may be flat.

The first groove may be recessed outward in a radial direction of the yoke member.

The camera module may further include a carrier that accommodates the lens module; and an autofocus (AF) driving portion disposed outside the carrier and configured to move the lens module and the carrier in a direction of an optical axis.

The camera module may further include a frame disposed on one surface of the lens holder; and an optical image stabilization (OIS) driving portion disposed outside the lens holder and configured to move the frame and the lens holder in a direction perpendicular to a direction of an optical axis.

Other features and examples will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates a schematic exploded perspective view of the example camera module, in accordance with one or more embodiments.

FIG. 3 illustrates an exploded perspective view of a holder member and a yoke member, in accordance with one or more embodiments.

FIG. 4 illustrates a perspective view of a lens holder, in accordance with one or more embodiments.

FIG. 5 is a plane view illustrating an example in which a lens barrel and the lens holder are coupled.

FIG. 6 illustrates a perspective view of the lens holder, in accordance with one or more embodiments.

FIG. 7 is a view illustrating a temperature change of the lens holder when ultraviolet light is irradiated.

FIG. 8 is a view illustrating a temperature change of the lens holder when ultraviolet light is irradiated.

FIG. 9 is a view illustrating a temperature change of the lens holder during a curing reaction of an adhesive.

FIG. 10 is a view illustrating a temperature change of the lens holder during the curing reaction of the adhesive.

FIG. 11 is a cross-sectional view illustrating the lens barrel, in accordance with one or more embodiments.

FIG. 12 is a view illustrating roundness of the lens barrel according to a comparative example and an example embodiment.

FIG. 13 is a view illustrating concentricity of the lens barrel according to the comparative example and the example embodiment.

FIG. 14 is a view illustrating coaxiality of the lens barrel according to the comparative example and the example embodiment.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning, e.g., the phrasing “in one example” has a same meaning as “in one embodiment”, and “one or more examples” has a same meaning as “in one or more embodiments.”

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Further, throughout the specification, the phrase “on a plane” means viewing a target portion from the top, and the phrase “on a cross-section” means viewing a cross-section formed by perpendicularly cutting a target portion from the side.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

A lens module, in accordance with one or more embodiments, may be provided in a camera module mounted on a portable electronic device.

In the one or more examples, the portable electronic device may refer to a portable electronic device such as a mobile communication terminal, a smart phone, a tablet personal computer (PC), or the like, as only examples.

One or more examples may provide a lens module that reduces a temperature change of a lens holder and a deformation of a lens barrel in a bonding process between the lens barrel and the lens holder, and a camera module including the lens module.

According to the lens module and the camera module including the same according to the embodiments, a temperature change of a lens holder and deformation of a lens barrel may be reduced in a bonding process between the lens barrel and the lens holder.

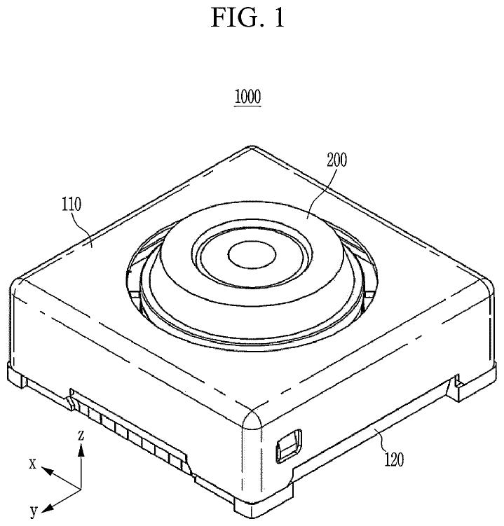

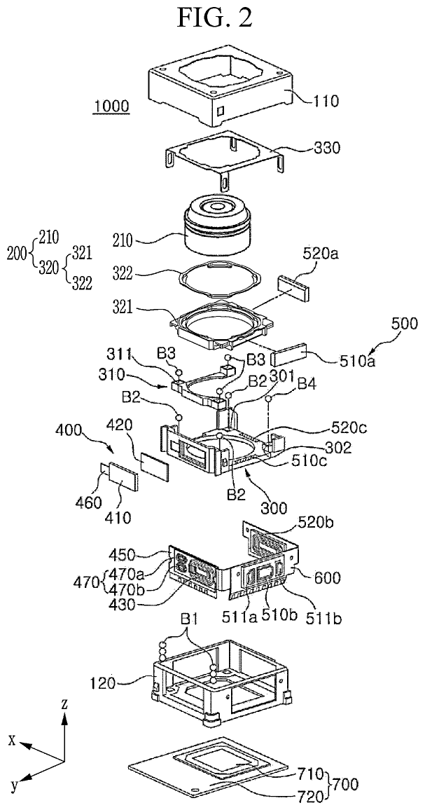

FIG. 1 illustrates a perspective view of an example camera module, in accordance with one or more embodiments, and FIG. 2 is a schematic exploded perspective view of the example camera module, in accordance with one or more embodiments.

Referring to FIGS. 1 and 2, the camera module 1000, in accordance with one or more embodiments, may include the lens module 200, a lens driving device that moves the lens module 200, an image sensor module 700 that converts light incident through the lens module 200 to an electrical signal, a housing 120 that accommodates the lens module 200 and the lens driving device therein, a cover 110 coupled to cover an outer surface of the housing 120, and a circuit board 720 coupled to a lower portion of the housing 120 and at which an image sensor 710 is mounted.

The lens module 200 may include a lens barrel 210 that accommodates at least one lens therein and a lens holder 320 coupled to the lens barrel 210. The lens holder 320 may include a holder member 321 and a yoke member 322 disposed on the holder member 321.

The lens barrel 210 may have a hollow cylindrical shape so that a plurality of lenses that capture an image of a subject may be accommodated therein. The plurality of lenses may be mounted at the lens barrel 210 along an optical axis (a z-axis in the drawings).

The plurality of lenses may be disposed as many as necessary according to an implementation of the lens barrel 210, and may have the same or different optical properties (e.g., a refractive index or the like).

The lens driving device may move the lens module 200. For example, the lens driving device may adjust a focus by moving the lens module 200 in a direction of the optical axis (the z-axis), and the lens driving device may correct shaking during an image capture operation by moving the lens module 200 in a direction (an x-axis direction and/or a y-axis direction) perpendicular to the optical axis (the z-axis).

The lens driving device may include a focus adjustment portion (or a focus adjustment part) 400 that adjusts the focus and a shaking correction portion (or a shaking correction part) 500 that corrects the shaking.

The image sensor module 700 may convert light passing through the lens to the electrical signal. For example, the image sensor module 700 may include the image sensor 710 and the circuit board 720 connected to the image sensor 710, and may further include an infrared filter. For example, the circuit board 720 may be a printed circuit board, and may be coupled to the lower portion of the housing 120. The infrared filter may block light in an infrared region among light passing through the lens.

The image sensor 710 may convert light passing through the lens to the electrical signal. As an example, the image sensor 710 may be a charge coupled device (CCD) or a complementary metal-oxide semiconductor (CMOS). The electrical signal converted by the image sensor 710 may be output as an image through a display unit of the portable electronic device. The image sensor 710 may be fixed to the circuit board 720, and may be electrically connected to the circuit board 720 by wire bonding.

The lens module 200 and the lens driving device may be accommodated in the housing 120. For example, the housing 120 may have a top and bottom open shape, and the lens module 200 and the lens driving device may be accommodated in an inner space of the housing 120. The image sensor module 700 may be disposed below the housing 120.

Additionally, a substrate (or a board) 600 that provides a driving signal to the focus adjustment portion 400 and the shaking correction portion 500 may be disposed at a side surface of the housing 120. In an example, the substrate 600 may be provided as one substrate surrounding the side surface of the housing 120. As will be described later, openings may be provided at side surfaces of the housing 120 so that an auto focus (AF) driving coil 430 and a first position detection portion 470 of the focus adjustment portion 400, and a first OIS driving coil 510b, a second OIS driving coil 520b, and a second position detection portion of the shaking correction portion 500 are inserted in the openings.

The cover 110 may be combined with the housing 120, and may serve to protect internal components of the camera module 100. Additionally, the cover 110 may operate to shield an electromagnetic wave. In an example, the cover 110 may shield the electromagnetic wave so that the electromagnetic wave generated in the camera module does not affect another electronic component within the portable electronic device. Additionally, since various electronic components other than the camera module may be mounted in the portable electronic device, the cover 110 may shield the electromagnetic wave so that the electromagnetic wave generated in the electronic components does not affect the camera module. The cover 110 may be made of a metal material to be grounded to a ground pad provided at the circuit board 720 so that the electromagnetic wave is shielded.

Hereinafter, with reference to FIG. 2, the focus adjustment portion 400 of the lens driving device of the camera module 1000, in accordance with one or more embodiments, will be described.

In order to focus on a subject, the lens module 200 may be moved by the lens driving device. In an example, the camera module 1000, in accordance with one or more embodiments, may include the focus adjustment portion 400 that moves the lens module 200 in a direction of the optical axis (the z-axis). The focus adjustment portion 400 may include a carrier 300 that accommodates the lens module 200, and an AF driving portion disposed outside the carrier 300 and that generates a driving force to move the lens module 200 and the carrier 300 in the direction of the optical axis (the z-axis). The AF driving portion may include an AF driving magnet 410 and the AF driving coil 430.

The AF driving magnet 410 may be mounted at the carrier 300. In an example, the AF driving magnet 410 may be mounted at one surface of the carrier 300.

The AF driving coil 430 may be disposed to face the AF driving magnet 410. The AF driving coil 430 may be a copper foil pattern stacked and embedded in the substrate 600. The substrate 600 may be mounted at the side surface of the housing 120 so that the AF driving magnet 410 and the AF driving coil 430 face each other in a direction perpendicular to the optical axis (the z-axis).

The AF driving magnet 410 may be a moving member mounted at the carrier 300 to move in the direction of the optical axis (the z-axis) together with the carrier 300, and the AF driving coil 430 may be a fixed member fixed to the housing 120. When electrical power is applied to the AF driving coil 430, the carrier 300 may be moved in the direction of the optical axis (the z-axis) based on an electromagnetic influence or interaction between the AF driving magnet 410 and the AF driving coil 430.

As shown in FIG. 2, a frame 310, a holder member 321, and the yoke member 322 may be accommodated in the carrier 300. Additionally, since the lens barrel 210 is mounted at the lens holder 320, the frame 310, the lens holder 320, and the lens barrel 210 may move in the direction of the optical axis (the z-axis) based on a movement of the carrier 300.

When the carrier 300 is moved, a first rolling member B1 may be disposed between the carrier 300 and the housing 120 to reduce friction between the carrier 300 and the housing 120. The first rolling member B1 may have a ball shape. For example, the first rolling member B1 may be disposed at both sides of the AF driving magnet 410, and may have a shape in which a plurality of balls are connected.

A first yoke 450 may be disposed to face the AF driving magnet 410 in a direction perpendicular to the optical axis (the z-axis). For example, the first yoke 450 may be mounted at an outer side surface (a surface opposite to a surface where the AF driving coil 430 is embedded) of the substrate 600. Accordingly, the first yoke 450 may be disposed to face the AF driving magnet 410 with the AF driving coil 430 interposed therebetween. An attractive force may act between the first yoke 450 and the AF driving magnet 410 in a direction perpendicular to the optical axis (the z-axis). Accordingly, the first rolling member B1 may maintain a contact state with the carrier 300 and the housing 120 based on the attractive force between the first yoke 450 and the AF driving magnet 410.

Additionally, the first yoke 450 may operate to focus a magnetic force of the AF driving magnet 410. Accordingly, it is possible to prevent leakage magnetic flux from occurring. In an example, the first yoke 450 and the AF driving magnet 410 may form a magnetic circuit.

A second yoke 420 may be disposed between the AF driving magnet 410 and the carrier 300. The second yoke 420 may operate to focus a magnetic force of the AF driving magnet 410. Accordingly, it is possible to prevent leakage magnetic flux from occurring. In an example, the second yoke 420 and the AF driving magnet 410 may form a magnetic circuit.

In an example, the camera module 1000, in accordance with one or more embodiments, may use a closed loop control method that detects and feeds back a position of the lens module 200. Therefore, the first position detection portion 470 may be provided for closed-loop control. The first position detection portion 470 may include a plurality of coils 470a and 470b and a control portion electrically connected to the plurality of coils 470a and 470b. The first position detection portion 470 may include a plurality of coils disposed along the direction of the optical axis (the z-axis). In an example, the first position detection portion 470 may include two coils 470a and 470b disposed along the direction of the optical axis (the z-axis). Like the AF driving coil 430, the plurality of coils 470a and 470b may be a copper foil pattern stacked and embedded in the substrate 600. In the embodiment of FIG. 2, two coils 470a and 470b are shown, but the one or more examples are not limited thereto.

The plurality of coils 470a and 470b of the first position detection portion 470 may be disposed to face a sensing yoke 460 disposed adjacent to the AF driving magnet 410. The sensing yoke 460 may be mounted on one surface of the carrier 300, and the sensing yoke 460 may be a conductive material or a magnetic material. The plurality of coils 470a and 470b may be disposed to face the sensing yoke 460 in a direction perpendicular to the optical axis (the z-axis). Additionally, the plurality of coils 470a and 470b may be disposed at a position adjacent to the AF driving coil 430.

As the carrier 300 moves in the direction of the optical axis (the z-axis), the sensing yoke 460 mounted at the carrier 300 may also move in the direction of the optical axis (the z-axis). Accordingly, inductances of the plurality of coils 470a and 470b may change. The control portion may receive inductance values from the plurality of coils 470a and 470b to detect a position (a position in the direction of the optical axis (the z-axis)) of the lens barrel 210. Therefore, the control portion may detect a position of the sensing yoke 460 from changes in the inductances of the plurality of coils 470a and 470b. The sensing yoke 460 may be mounted at the carrier 300, and the lens barrel 210 may be accommodated in the carrier 300. Since the carrier 300 is moved in the direction of the optical axis (the z-axis) together with the lens barrel 210, eventually, the first position detection portion 470 may detect (or sense) the position (the position in the direction of the optical axis (the z-axis)) of the lens barrel 210 from the changes in the inductances of the plurality of coils 470a and 470b.

When the sensing yoke 460 moves in the direction of the optical axis (the z-axis), the position of the lens barrel 210 in the direction of the optical axis (the z-axis) may be more accurately detected using a signal difference generated by the two coils 470a and 470b of the first position detection portion 470. The inductance values of the two coils 470a and 470b may be changed not only by a relative position difference with the sensing yoke 460 but also by a temperature change in a surrounding environment or the like.

However, in the one or more examples, an exact position of the lens barrel 210 may be detected by removing a factor caused by the temperature change in the surrounding environment or the like. In an example, as the sensing yoke 460 moves, the inductances of the two coils 470a and 470b may have different increasing and decreasing directions. That is, when the inductance of one coil 470a increases, the inductance of the other coil 470b may decrease. Therefore, when the inductance values of the plurality of coils 470a and 470b are subtracted from each other, the factor caused by the temperature change in the surrounding environment may be removed, and accordingly, the position of the lens barrel 210 in the direction of the optical axis (the z-axis) may be accurately detected.

On the other hand, it has been described that the plurality of coils 470a and 470b of the first position detection portion 470 face the sensing yoke 460 in the one or more examples, but it may be possible to dispose the plurality of coils 470a and 470b to face the AF driving magnet 410 without separately providing the sensing yoke 460. In addition, it is illustrated that the plurality of coils 470a and 470b of the first position detection portion 470 are two and the AF driving coil 430 is one in the present embodiment, but the present disclosure is not limited thereto.

Next, still referring to FIG. 2, the shaking correction portion 500 of the lens driving devices of the camera module 1000, in accordance with one or more embodiments, will be described.

The shaking correction portion 500 may be used to correct blurring of an image or shaking of a moving image due to a factor such as a user's hand-shake or the like when the image or the moving image is captured. For example, when the shaking occurs due to the user's hand shake or the like when the image is captured, the shaking correction portion 500 may compensate for the shaking by providing a relative displacement corresponding to the shaking to the lens barrel 210. As a specific example, the shaking correction portion 500 may correct the shaking by moving the lens barrel 210 in a direction perpendicular to the optical axis (the z-axis).

The shaking correction portion 500 may include a guide member that guides movement of the lens barrel 210, and an OIS driving portion that is disposed outside the lens holder 320 and generates a driving force to move the guide member in the direction perpendicular to the optical axis (the z-axis). The OIS driving portion may include a plurality of optical image stabilization (OIS) driving magnets and a plurality of OIS driving coils.

The plurality of OIS driving magnets may include a first OIS driving magnet 510a and a second OIS driving magnet 520a, and the plurality of OIS driving coils may include the first OIS driving coil 510b and the second OIS driving coil 520b.

The guide member may include the frame 310 and the lens holder 320. The frame 310 and the lens holder 320 may be sequentially inserted into the carrier 300 along the direction of the optical axis (the z-axis), and may operate to guide the movement of the lens barrel 210.

The frame 310 and the lens holder 320 may have a space into which the lens barrel 210 may be inserted. The lens barrel 210 may be inserted and fixed into the lens holder 320. The frame 310 may be disposed on one surface of the lens holder 320.

In an example, the frame 310 of the guide member may be a shape in which two sides of a quadrangle are removed when viewed in the direction of the optical axis (the z-axis). The first OIS driving magnet 510a and the second OIS driving magnet 520a may be respectively disposed on two open sides of the frame 310. Accordingly, disposition positions of the first OIS driving magnet 510a and the second OIS driving magnet 520a may not be affected by the frame 310, and accordingly, an overall height of the camera module may not increase. However, a shape of the frame 310 is not limited thereto, and various shapes such as a quadrangular planar shape and the like may be possible depending on a purpose.

The frame 310 and the lens holder 320 may move in a direction perpendicular to the optical axis (the z-axis) with respect to the carrier 300 due to a driving force generated by the plurality of OIS driving magnets and the plurality of OIS driving coils. The first OIS driving magnet 510a and the first OIS driving coil 510b may generate a driving force in a direction of a first axis (an x-axis) perpendicular to the optical axis (the z-axis), and the second OIS driving magnet 520a and the second OIS driving coil 520b may generate a driving force in a direction of a second axis (a y-axis) perpendicular to the first axis (the x-axis). That is, the plurality of OIS driving magnets and the plurality of OIS driving coils may generate a driving force in directions facing each other. In the one or more examples, the second axis (the y-axis) may mean an axis perpendicular to both the optical axis (the z-axis) and the first axis (the x-axis).

The plurality of OIS driving magnets may be disposed to be orthogonal to each other in a plane perpendicular to the optical axis (the z-axis), and the plurality of OIS driving coils may also be disposed to be orthogonal to each other in the plane perpendicular to the optical axis (the z-axis).

The first OIS driving magnet 510a and the second OIS driving magnet 520a may be mounted at the holder member 321. For example, the first OIS driving magnet 510a and the second OIS driving magnet 520a may be respectively mounted at a side surface of the holder member 321. The side surface of the holder member 321 may include first and second surfaces perpendicular to each other, and the first OIS driving magnet 510a and the second OIS driving magnet 520a may be disposed at the first and second surfaces of the holder member 321.

The first OIS driving coil 510b and the second OIS driving coil 520b may be a copper foil pattern that is stacked and embedded in the substrate 600. The first OIS driving magnet 510a and the first OIS driving coil 510b may face each other in a direction of the first axis (the x-axis) perpendicular to the optical axis (the z-axis), and the second OIS driving magnet 520a and the second OIS driving coil 520b may be mounted on the side surface of the housing 120 so as to face each other in a direction of the second axis (the y-axis) perpendicular to the optical axis (the z-axis) and the first axis (the x-axis).

The first OIS driving magnet 510a and the second OIS driving magnet 520a may be a moving member that moves in the direction perpendicular to the optical axis (the z-axis) together with the lens holder 320, and the first OIS driving coil 510b and the second OIS driving coil 520b may be a fixed member that is fixed to the housing 120.

In the one or more examples, a plurality of rolling members supporting the frame 310 and the lens holder 320 of the shaking correction portion 500 may be provided. The plurality of rolling members may operate to guide movements of the frame 310, the lens holder 320, and the lens barrel 210 in a shaking correction process. Additionally, the plurality of rolling members may also operate to maintain a distance between the carrier 300, the frame 310, and the lens holder 320. A second rolling member B2 and a third rolling member B3 may have a ball shape.

The plurality of rolling members may include the second rolling member B2 and the third rolling member B3. In an example, the second rolling member B2 may guide the movements of the frame 310, the lens holder 320, and the lens barrel 210 in the direction of the first axis (the x-axis). In addition, the third rolling member B3 may guide the movements of the lens holder 320 and the lens barrel 210 in the direction of the second axis (the y-axis). As a specific example, the second rolling member B2 may roll in the direction of the first axis (the x-axis) when a driving force is generated in the direction of the first axis (the x-axis). Accordingly, the second rolling member B2 may guide the movements of the frame 310, the lens holder 320, and the lens barrel 210 in the direction of the first axis (the x-axis).

As another specific example, the third rolling member B3 may roll in the direction of the second axis (the y-axis) when a driving force is generated in the direction of the second axis (the y-axis). Accordingly, the third rolling member B3 may guide the movements of the lens holder 320 and the lens barrel 210 in the direction of the second axis (the y-axis).

The second rolling member B2 may include a plurality of rolling members disposed between the carrier 300 and the frame 310. The third rolling member B3 may include a plurality of rolling members disposed between the frame 310 and the lens holder 320.

A first guide groove portion 301 that accommodates the second rolling member B2 may be respectively disposed at surfaces of the carrier 300 where the carrier 300 and the frame 310 face each other in the direction of the optical axis (the z-axis). The first guide groove portion 301 may include a plurality of guide grooves corresponding to the plurality of rolling members of the second rolling member B2. The second rolling member B2 may be accommodated in the first guide groove portion 301 to be inserted between the carrier 300 and the frame 310.

In an example where the second rolling member B2 is accommodated in the first guide groove portion 301, a movement of the second rolling member B2 in the direction of the optical axis (the z-axis) and a movement of the second rolling member B2 in the direction of the second axis (the y-axis) may be limited, and the second rolling member B2 may be moved only in the direction of the first axis (the x-axis). In an example, the second rolling member B2 may roll only in the direction of the first axis (the x-axis). For this purpose, a planar shape of each guide groove of the first guide groove portion 301 may be a rectangle having a length in the direction of the first axis (the x-axis).

A second guide groove portion 311 that accommodates the third rolling member B3 may be respectively disposed at surfaces in which the frame 310 and the lens holder 320 face each other in the direction of the optical axis (the z-axis). The second guide groove portion 311 may include a plurality of guide grooves corresponding to the plurality of rolling members of the third rolling member B3. The third rolling member B3 may be accommodated in the second guide groove portion 311 to be inserted between the frame 310 and the lens holder 320.

In an example where the third rolling member B3 is accommodated in the second guide groove portion 311, a movement of the third rolling member B3 in the direction of the optical axis (the z-axis), and a movement of the third rolling member B3 in the direction of the first axis (x-axis) may be limited, and the third rolling member B3 may be moved only in the direction of the second axis (the y-axis). In an example, the third rolling member B3 may roll only in the direction of the second axis (the y-axis). For this purpose, a planar shape of each guide groove of the second guide groove portion 311 may be a rectangle having a length in the direction of the second axis (the y-axis).

Additionally, the camera module 1000, in accordance with one or more embodiments, may include a fourth rolling member B4 disposed between the carrier 300 and the lens holder 320 to support a movement of the lens holder 320. The fourth rolling member B4 may support the lens holder 320 moving in the direction of the first axis (the x-axis) and in the direction of the second axis (the y-axis). In an example, the fourth rolling member B4 may roll along the first axis (the x-axis) when a driving force is generated in the direction of the first axis (the x-axis). Additionally, the fourth rolling member B4 may roll along the second axis (the y-axis) when a driving force is generated in the direction of the second axis (the y-axis).

The third rolling member B3 and the fourth rolling member B4 may contact and support the lens holder 320. An accommodating groove 302 that accommodates the fourth rolling member B4 may be disposed at one or more of surfaces in which the carrier 300 and the lens holder 320 face each other in the direction of the optical axis (the z-axis). The fourth rolling member B4 may be accommodated in the accommodating groove 302 to be inserted between the carrier 300 and the lens holder 320. In an example where the fourth rolling member B4 is accommodated in the accommodating groove 302, a movement of the fourth rolling member B4 in the direction of the optical axis (the z-axis) may be limited, and the fourth rolling member B4 may roll along the first axis (the x-axis) and the second axis (the y-axis). For this purpose, the accommodating groove 302 may be formed in a circular planar shape. Therefore, shapes of the accommodating groove 302, the first guide groove portion 301, and the second guide groove portion 311 may be different from each other.

On the other hand, the camera module 1000, in accordance with one or more embodiments, may include a plurality of yokes 510c and 520c so that the shaking correction portion 500 and the second to fourth rolling members B2, B3, and B4 maintain a contact state. The plurality of yokes 510c and 520c may be fixed to the carrier 300, and may be disposed to face the first OIS driving magnet 510a and the second OIS driving magnet 520a in the direction of the optical axis (the z-axis). Accordingly, an attractive force may be generated between the plurality of yokes 510c and 520c and the first OIS driving magnet 510a and the second OIS driving magnet 520a in the direction of the optical axis (the z-axis).

The shaking correction portion 500 may be pressed in a direction toward the plurality of yokes 510c and 520c based on the attractive force between the plurality of yokes 510c and 520c, and the first OIS driving magnet 510a and the second OIS driving magnet 520a. Accordingly, the frame 310 and the lens holder 320 of the shaking correction portion 500 may maintain a contact state with the second to fourth rolling members B2, B3, and B4.

The plurality of yokes 510c and 520c may be a material that generates an attractive force between the first OIS driving magnet 510a and the second OIS driving magnet 520a. In an example, the plurality of yokes 510c and 520c may be provided as a magnetic material.

The camera module 1000, in accordance with one or more embodiments, may include a stopper 330 that prevents the second to fourth rolling members B2, B3, and B4, the frame 310, and the lens holder 320 from escaping to the outside of the carrier 300 based on an external impact or the like. The stopper 330 may be coupled to the carrier 300 to cover at least a portion of an upper surface of the lens holder 320.

The camera module 1000, in accordance with one or more embodiments, may use a closed-loop control method that detects and feeds back a position of the lens barrel 210 in the shaking correction process, and thus may include the second position detection portion for closed-loop control. The second position detection portion may be configured to detect a position in the direction of the first axis (the x-axis) and a position in the direction of the second axis (the y-axis) of the lens barrel 210. The second position detection portion may include a plurality of coils and a control portion electrically connected to the plurality of coils. The control portion may receive inductance values from the plurality of coils to detect the position in the direction of the first axis (the x-axis) and the position in the direction of the second axis (the y-axis) of the lens barrel 210.

Similar to the first OIS driving coil 510b, the plurality of coils may also be a copper foil pattern that is stacked and embedded in the substrate 600. The plurality of coils may be disposed at both sides of the first OIS driving coil 510b or the second OIS driving coil 520b. In an example, when the plurality of coils includes two coils, the two coils may be disposed at both sides of the first OIS driving coil 510b or the second OIS driving coil 520b.

Hereinafter, for convenience of description, it is described that the plurality of coils are disposed at both sides of the first OIS driving coil 510b. However, this is only an example, and the one or more examples are not limited thereto, and the plurality of coils may be disposed at both sides of the second OIS driving coil 520b or the plurality of coils may not be disposed at both sides of the second OIS driving coil 520b.

The first OIS driving magnet 510a may be disposed to face the first OIS driving coil 510b in the direction of the first axis (the x-axis). Additionally, a first side of the first OIS driving magnet 510a may be disposed to face a portion of one of the plurality of coils of the second position detection portion, and a second side of the first OIS driving magnet 510a may be disposed to face a portion of the other of the plurality of coils of the second position detection portion. In an example, the coil having the portion facing the first side of the first OIS driving magnet 510a may be a (1-1)-th sensing coil 511a, and the coil having the portion facing the second side of the first OIS driving magnet 510a may be a (1-2)-th sensing coil 511b.

As the first OIS driving magnet 510a is moved in the direction of the first axis (the x-axis) and/or in the direction of the second axis (the y-axis), inductances of the plurality of coils of the second position detection portion may change. Accordingly, a position of the first OIS driving magnet 510a may be detected from changes in the inductances of the plurality of coils. The first OIS driving magnet 510a may be mounted at the lens holder 320, the lens barrel 210 may be mounted at the lens holder 320, and the lens holder 320 may be moved together with the lens barrel 210 in the direction of the first axis (the x-axis) and/or in the direction of the second axis (the y-axis). Accordingly, a position (a position in the direction of the first axis (the x-axis) and/or a position in the direction of the second axis (the y-axis)) of the lens barrel 210 may be detected from the changes in the inductances of the plurality of coils of the second position detection portion.

The second rolling member B2 may be accommodated in the first guide groove portion 301 to be disposed between the carrier 300 and the frame 310. The third rolling member B3 may be accommodated in the second guide groove portion 311 to be disposed between the frame 310 and the lens holder 320. The fourth rolling member B4 may be accommodated in the accommodating groove 302 to be disposed between the carrier 300 and the lens holder 320.

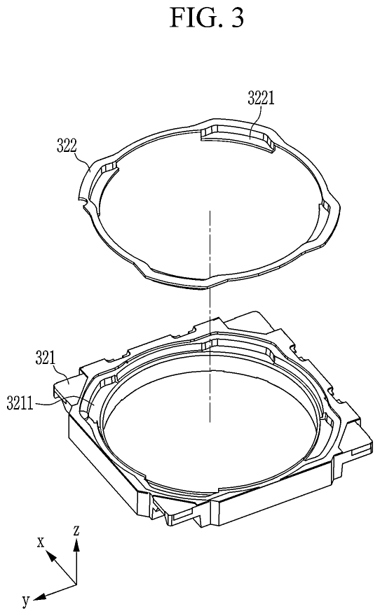

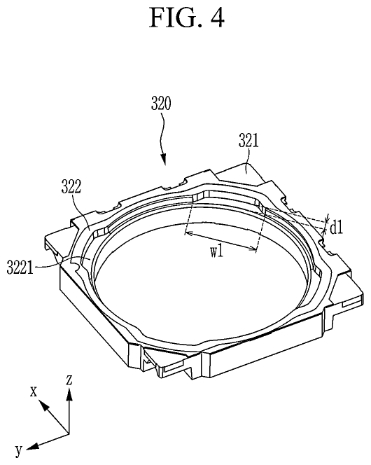

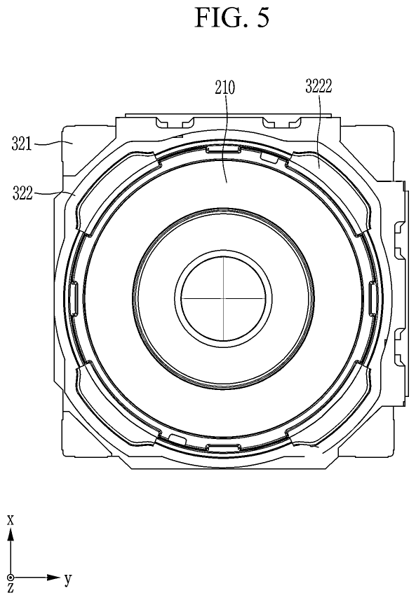

Hereafter, the holder member 321 and the yoke member 322, in accordance with one or more embodiments, will be described in detail with reference to FIGS. 3 to 5. FIG. 3 is an exploded perspective view of the holder member and the yoke member, in accordance with one or more embodiments, FIG. 4 is a perspective view of the lens holder, in accordance with one or more embodiments, and FIG. 5 is a plane view illustrating an example in which the lens barrel and the lens holder are coupled.

When the lens barrel 210 and the lens holder 320 are coupled using an adhesive 3222, the adhesive 3222 may be first filled in an adhesive portion (for example, first groove 3221), and ultraviolet rays may be irradiated to the adhesive portion. When ultraviolet rays are irradiated, the lens barrel 210 and the lens holder 320 may undergo thermal expansion. In an example, since the adhesive 3222 may be in a liquid state and the lens barrel 210 and the lens holder 320 are not bonded, the lens barrel 210 and the lens holder 320 may not affect each other.

After that, adhesion between the lens barrel 210 and the lens holder 320 may be made to some extent, and a curing reaction may occur in the adhesive 3222 so that the adhesive 3222 may heat up and shrink. In a non-limited example, the adhesive 3222 may be in a gel state, and temperatures of portions of the lens barrel 210 and the lens holder 320 may increase. Additionally, the lens barrel 210 and the lens holder 320 may affect each other and deformation may occur between the lens barrel 210 and the lens holder 320.

Adhesion between the lens barrel 210 and the lens holder 320 may be completely completed, and the temperatures of the portions of the lens barrel 210 and the lens holder 320 may decrease to room temperature again. in an example, while the lens holder 320 is thermally contracted, the lens holder 320 may push the lens barrel 210 and may cause the deformation. In a non-limited example, the adhesive 3222 may be in a solid state.

Referring to FIGS. 3 to 5, the lens module 200, in accordance with one or more embodiments, may include the lens barrel 210, the holder member 321, and the yoke member 322 disposed above or on the holder member 321. The yoke member 322 may have a ring shape, but the one or more examples are not limited thereto. The yoke member 322 may be disposed on any one of an upper surface and a lower surface according to the direction of the optical axis of the holder member 321.

A first groove 3221 may be disposed at an inner circumferential surface of the yoke member 322. The adhesive 3222 may be filled in the first groove 3221. To prevent the adhesive 3222 from flowing down, a bottom surface of the first groove 3221 may be flat. The first groove 3221 may include the bottom surface and a side surface connected to the bottom surface. The first groove 3221 may have a shape that is open toward a center of the yoke member 322 so that the adhesive 3222 filled in the first groove 3221 contacts the lens barrel 210 inserted into the lens holder 320. The first groove 3221 may have a shape depressed from an upper surface of the yoke member 322 in the direction of the optical axis. The first groove 3221 may be a shape depressed outward in a radial direction of the yoke member 322. In an example, in order to provide sufficient coupling force between the lens barrel 210 and the lens holder 320, a depth d1 of the first groove 3221 along a direction perpendicular to the direction of the optical axis may be 0.1 mm or more. Additionally, in order to provide sufficient coupling force between the lens barrel 210 and the lens holder 320, a width w1 of the bottom surface of the first groove 3221 may be 0.3 mm or more.

The inner circumferential surface of the yoke member 322 may include a plurality of first grooves 3221. The holder member 321 may have a plurality of corner regions, and each of the plurality of first grooves 3221 may be disposed at the corner region of the holder member 321. Additionally, each of the plurality of first grooves 3221 may be disposed to face each other in a diagonal direction of the yoke member 322. In an example, the first grooves 3221 may be disposed at four corner regions of the holder member 321 so as to face each other in the diagonal direction of the yoke member 322. Accordingly, sufficient adhesive force may be secured, and thermal deformation due to a heat generation phenomenon may be prevented when the adhesive 3222 is excessively filled.

To allow the yoke member 322 to be seated on one surface of the holder member 321, the holder member 321 may have a second groove 3211 corresponding to the first groove 3221 disposed at the yoke member 322 on a surface opposite to the yoke member 322. The second groove 3211 may have a shape that is open toward a center of the holder member 321. The second groove 3211 may have a shape that is depressed from an upper surface of the holder member 321 in the direction of the optical axis. The second groove 3211 may be a shape that is depressed outward in a radial direction of the holder member 321.

The holder member 321 and the yoke member 322 may be formed from different materials. The holder member 321 may be formed from a first material, and the yoke member 322 may be formed from a second material different from the first material. In an example, a value obtained by multiplying a density of the second material by a specific heat of the second material may be greater than a value obtained by multiplying a density of the first material by a specific heat of the first material. In an example, the first material may include polycarbonate (PC), and the second material may include stainless steel, phosphor bronze, or the like, as only examples. As described above, since the value obtained by multiplying the density of the second material by the specific heat of the second material is greater than the value obtained by multiplying the density of the first material by the specific heat of the first material, a temperature change value of the yoke member 322 including the second material may be less than a temperature change value of the holder member 321 including the first material by an energy equation such as Equation 1 below. Therefore, heat generated in the lens holder 320 and deformation caused by the heat may be reduced compared with an example in which the yoke member 322 is not disposed on the holder member 321 when ultraviolet rays are irradiated.

$$Q = {mC}_{p} dT = ρ {VC}_{p} dT \qquad Equation 1$$

$$dT = \frac{Q}{ρ {C}_{p} V}$$

In Equation 1, Q is a thermal energy, m is a mass, ρ is a density, V is a volume, Cₚ is a specific heat, and dT is a change in temperature.

In another example, the second material may have a higher thermal-conductivity characteristic than the first material. Accordingly, a thermal conductivity of the yoke member 322 may be higher than a thermal conductivity of the holder member 321. Therefore, the heat generated in the lens holder 320 and the deformation caused by the heat may be reduced compared with the example in which the yoke member 322 is not disposed on the holder member 321 when ultraviolet rays are irradiated.

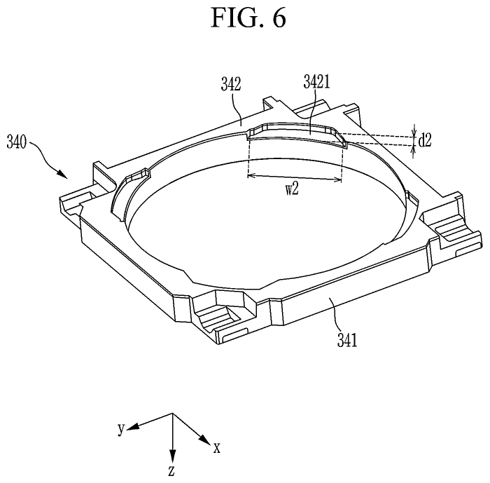

Hereinafter, the holder member and the yoke member, in accordance with one or more embodiments, will be described with reference to FIG. 6. FIG. 6 illustrates a perspective view of the lens holder, in accordance with one or more embodiments.

Referring to FIG. 6, the lens holder 340, in accordance with one or more embodiments, may include a holder member 341 and a yoke member 342 disposed above or on the holder member 341. The yoke member 342 may have a plate shape including a hole into which the lens barrel 210 is inserted. However, the one or more examples are not limited thereto. The yoke member 342 may be disposed on any one of an upper surface and a lower surface according to the direction of the optical axis of the holder member 341.

A first groove 3421 may be disposed at an inner circumferential surface of the yoke member 342. An adhesive may be filled in the first groove 3421. To prevent the adhesive from flowing down, a bottom surface of the first groove 3421 may be flat. The first groove 3421 may include a bottom surface and a side surface connected to the bottom surface. The first groove 3421 may have a shape that is open toward a center of the yoke member 342 so that the adhesive filled in the first groove 3421 contacts the lens barrel 210 inserted into the lens holder 320. In an example, in order to provide sufficient coupling force between the lens barrel 210 and the lens holder 340, a depth d2 of the first groove 3421 along a direction perpendicular to the direction of the optical axis may be 0.1 mm or more. Additionally, in an example, in order to provide sufficient coupling force between the lens barrel 210 and the lens holder 340, a width w2 of the bottom surface of the first groove 3421 may be 0.3 mm or more.

The inner circumferential surface of the yoke member 342 may include a plurality of first grooves 3421. The holder member 341 may have a plurality of corner regions, and, in an example, each of the plurality of first grooves 3421 may be disposed at the corner region of the holder member 341. Additionally, each of the plurality of first grooves 3421 may be disposed to face each other in a diagonal direction of the yoke member 342.

The holder member 341 and the yoke member 342 may have different materials. The holder member 341 may be formed of a first material, and the yoke member 342 may be formed of a second material that is different from the first material. A value obtained by multiplying a density of the second material by a specific heat of the second material may be greater than a value obtained by multiplying a density of the first material by a specific heat of the first material. In an example, the first material may include polycarbonate, and the second material may include stainless steel or phosphor bronze. As described above, since the value obtained by multiplying the density of the second material by the specific heat of the second material may be greater than the value obtained by multiplying the density of the first material by the specific heat of the first material, a temperature change value of the yoke member 342 including the second material may be less than a temperature change value of the holder member 341 including the first material by the energy equation such as Equation 1 described above. Accordingly, deformation due to heat generated in the lens holder 340 may be reduced compared with an example in which the yoke member 342 is not disposed on the holder member 341.

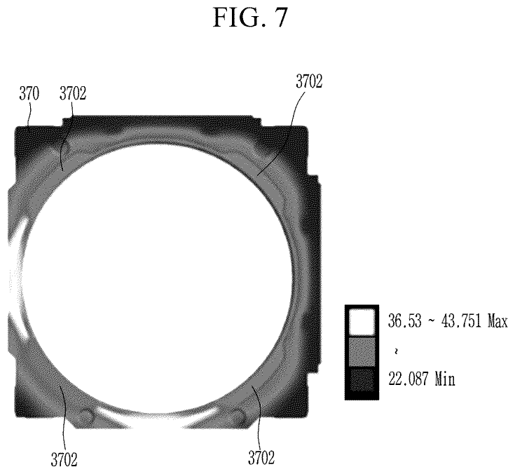

Hereafter, a simulation result of the lens holder 320 in a process of bonding the lens barrel 210 and the lens holder 320 will be described with reference to FIGS. 7 to 14.

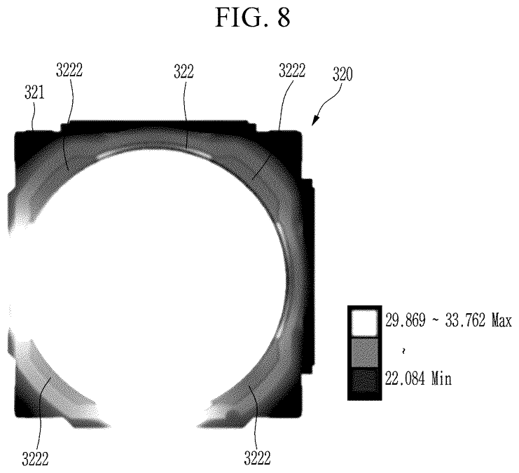

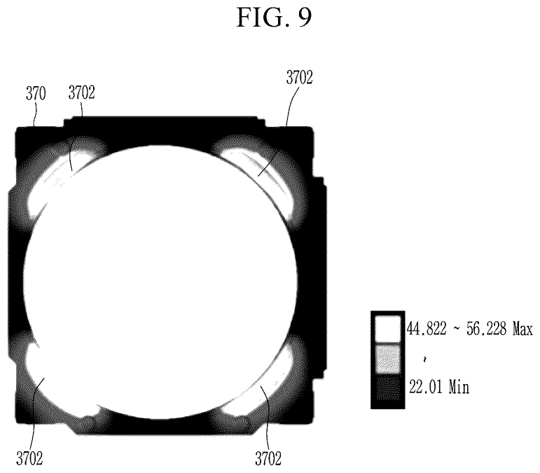

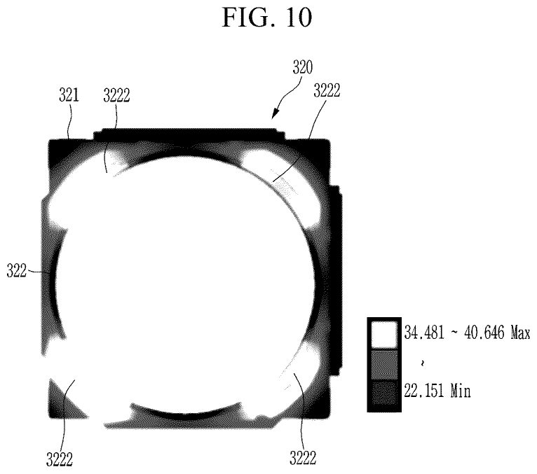

FIGS. 7 and 9 are views of a comparative example in which an adhesive 3702 is filled in a groove formed in a lens holder 370 that does not include the yoke member 322, and FIGS. 8 and 10 are views of an example in which the adhesive 3222 is filled in the first groove 3221 of the lens holder 320 in which the yoke member 322 is disposed on the holder member 321, in accordance with one or more embodiments. FIGS. 7 and 8 are views illustrating a temperature change of the lens holder when ultraviolet light is irradiated, and FIGS. 9 and 10 are views illustrating a temperature change of the lens holder during a curing reaction of the adhesive.

In a process of bonding the lens barrel 210 and the lens holder 320 or 370, a temperature change of the lens holder 320 or 370 when ultraviolet light is irradiated and a temperature change of the lens holder 320 or 370 during the curing reaction of the adhesive were simulated.

Referring to FIGS. 7 and 8, it may be confirmed that a temperature deviation when ultraviolet light is irradiated is 21.8° C. in an example of the lens holder 370 of the comparative example that does not include the yoke member 322. In an example, the temperature deviation may mean a difference between a temperature of a portion having the highest temperature of the lens holder 370 or 320 and a temperature of a portion having the lowest temperature of the lens holder 370 or 320. On the other hand, it may be confirmed that the temperature deviation when ultraviolet light is irradiated is 11.8° C. in an example of the lens holder 320 including the yoke member 322, in accordance with one or more embodiments. That is, it may be confirmed that the temperature deviation is reduced by about 0.54 times compared with the lens holder 370 of the comparative example not including the yoke member 322 in an example of the lens holder 320 in which the yoke member 322 is disposed on the holder member 321.

Referring to FIGS. 9 and 10, it may be confirmed that a temperature deviation during heat generation of the adhesive is 34.2° C. in an example of the lens holder 370 of the comparative example not including the yoke member 322. In an example, the temperature deviation may mean a difference between a temperature of a portion having the highest temperature of the lens holder 370 or 320 and a temperature of a portion having the lowest temperature of the lens holder 370 or 320. On the other hand, it may be confirmed that the temperature deviation during heat generation of the adhesive is 18.6° C. in a case of the lens holder 320 including the yoke member 322, in accordance with one or more embodiments. That is, it may be confirmed that the temperature deviation is reduced by about 0.54 times compared with the lens holder 370 of the comparative example not including the yoke member 322 in the example of the lens holder 320 in which the yoke member 322 is disposed on the holder member 321.

As described above, it may be confirmed that the temperature deviation of the lens holder 320 due to irradiation of ultraviolet rays and heat generation of the adhesive 3222 is greatly reduced since the yoke member 322 is disposed on one surface of the holder member 321. In other words, a process in which the lens holder 320 is thermally expanded by irradiation of ultraviolet rays and heat generation of the adhesive 3222 and a temperature again decreases after bonding between the lens barrel 210 and the lens holder 320 is completed so that the lens holder 320 is contracted, a force applied to the lens barrel 210 by the lens holder 320 may be reduced, and accordingly, a risk in which an optical defect occurs may also be reduced.

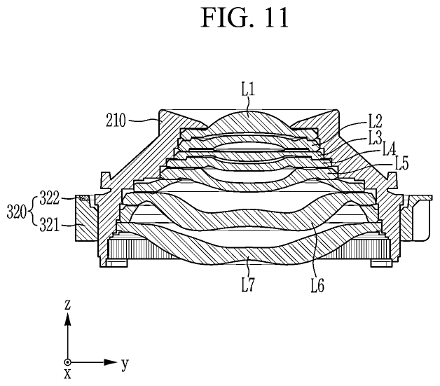

Hereinafter, roundness, concentricity, and coaxiality of the lens holder 320 will be described with reference to FIGS. 11 to 14.

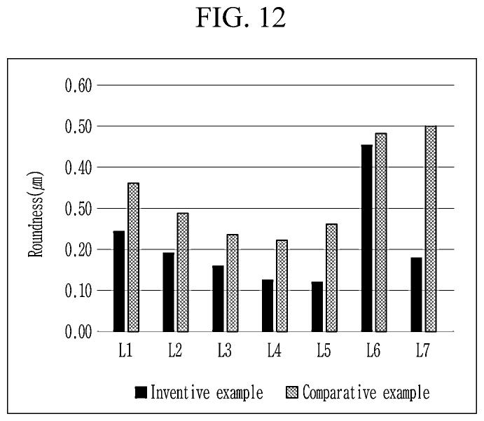

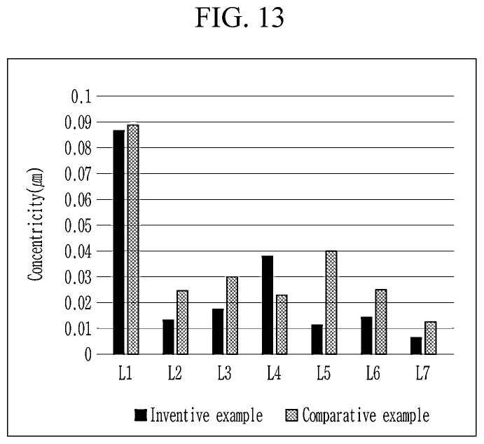

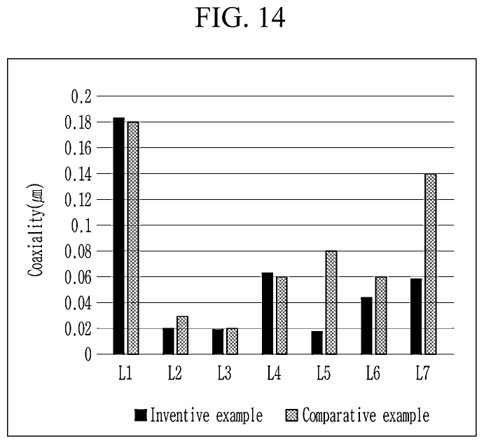

FIG. 11 is a cross-sectional view illustrating the lens barrel according to an embodiment, FIG. 12 is a view illustrating roundness of the lens barrel according to a comparative example and an embodiment, FIG. 13 is a view illustrating concentricity of the lens barrel according to the comparative example and the embodiment, and FIG. 14 is a view illustrating coaxiality of the lens barrel according to the comparative example and the embodiment.

Referring to FIG. 11, the lens barrel 210 may include a plurality of lenses L1, L2, L3, L4, L5, L6, and L7 sequentially stacked along the direction of the optical axis. In an example, the lens barrel 210 may include seven lenses L1, L2, L3, L4, L5, L6, and L7 sequentially stacked along the direction of the optical axis. The lens barrel 210, in accordance with one or more embodiments, may be bonded to the lens holder 320 including the holder member 321 and the yoke member 322. On the other hand, the lens barrel of the comparative example that will be described later may be bonded to the lens holder 370 of FIGS. 7 and 9 that does not include the yoke member 322.

Referring to FIG. 12, the roundness of the lens barrel 210, in accordance with one or more embodiments, is close to 0 compared with the roundness of the lens barrel of the comparative example. In other words, it may be seen that deformation of the lens barrel 210, in accordance with one or more embodiments, is small during the bonding process, and thus, a risk in which an optical defect occurs in the lens barrel 210 may be reduced. The roundness may mean a difference between a maximum value and a minimum value of a deformation amount of an inner diameter of the lens barrel at a position where the lens is seated.

Referring to FIG. 13, it may be seen that the concentricity of the lens barrel 210, in accordance with one or more embodiments, is generally less than that of the lens barrel of the comparative example. In other words, it may be seen that deformation of the lens barrel 210, in accordance with one or more embodiments, is small during the bonding process, and thus, a risk in which an optical defect occurs in in the lens barrel 210 may be reduced. The concentricity may mean a degree to which center positions of upper and lower surfaces of the lens are relatively displaced.

Referring to FIG. 14, it may be seen that the coaxiality of the lens barrel 210, in accordance with one or more embodiments, is generally smaller than that of the lens barrel of the comparative example. In other words, it may be seen that deformation of the lens barrel 210, in accordance with one or more embodiments, is small during the bonding process, and thus, a risk in which an optical defect occurs in the lens barrel 210 may be reduced. The coaxiality may mean a degree to which a center of the lens is displaced from the optical axis.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A lens module, comprising:
a lens barrel that accommodates at least one lens; and
a lens holder that is coupled to the lens barrel and includes a holder member comprising a first material and a yoke member that is disposed on the holder member along an inner edge of the holder member,
wherein a first groove is disposed at an inner circumferential surface of the yoke member, and the yoke member comprises a second material that is different from the first material of the holder member.

2. The lens module of claim 1, wherein the holder member has a second groove that corresponds to the first groove disposed at the yoke member, and the second groove on a surface of the holder member that is opposite to the yoke member.

3. The lens module of claim 2, wherein the second groove is recessed in a direction of an optical axis from an upper surface of the holder member.

4. The lens module of claim 1, wherein the holder member has a plurality of corner regions, the first groove comprises a plurality of first grooves, and each of the plurality of first grooves is disposed at the corner regions of the holder member.

5. The lens module of claim 4, wherein each of the plurality of first grooves is disposed to face each other in a diagonal direction of the yoke member.

6. The lens module of claim 1, wherein a thermal conductivity of the yoke member is higher than a thermal conductivity of the holder member.

7. The lens module of claim 1, wherein a value obtained by multiplying a density of the second material by a specific heat of the second material is greater than a value obtained by multiplying a density of the first material by a specific heat of the first material.

8. The lens module of claim 1, wherein the yoke member has a ring shape.

9. The lens module of claim 1, wherein an adhesive is filled in the first groove.

10. The lens module of claim 1, wherein the first material comprises polycarbonate (PC).

11. The lens module of claim 1, wherein the second material comprises stainless steel.

12. The lens module of claim 1, wherein a bottom surface of the first groove is flat.

13. The lens module of claim 1, wherein the first groove is recessed outward in a radial direction of the yoke member.

14. A camera module, comprising:
a lens module;
a housing that accommodates the lens module;
a cover that covers an outer surface of the housing; and
a circuit board, coupled to a lower portion of the housing, and having an image sensor mounted thereat,
wherein the lens module comprises a lens barrel that accommodates at least one lens, and a lens holder that is coupled to the lens barrel and comprises a holder member comprising a first material and a yoke member disposed on the holder member along an inner edge of the holder member, and
wherein a first groove is disposed at an inner circumferential surface of the yoke member, and the yoke member comprises a second material that is different from the first material of the holder member.

15. The camera module of claim 14, wherein the first groove comprises a plurality of first grooves, and each of the plurality of first grooves is disposed to face each other in a diagonal direction of the yoke member.

16. The camera module of claim 14, wherein a value obtained by multiplying a density of the second material by a specific heat of the second material is greater than a value obtained by multiplying a density of the first material by a specific heat of the first material.

17. The camera module of claim 14, wherein the yoke member has a ring shape.

18. The camera module of claim 14, wherein an adhesive is filled in the first groove.

19. The camera module of claim 14, wherein a bottom surface of the first groove is flat.

20. The camera module of claim 14, wherein the first groove is recessed outward in a radial direction of the yoke member.

21. The camera module of claim 14, further comprising:
a carrier that accommodates the lens module; and
an autofocus (AF) driving portion disposed outside the carrier and configured to move the lens module and the carrier in a direction of an optical axis.

22. The camera module of claim 14, further comprising:
a frame disposed on one surface of the lens holder; and
an optical image stabilization (OIS) driving portion disposed outside the lens holder and configured to move the frame and the lens holder in a direction perpendicular to a direction of an optical axis.
